(19) United States
(12) Patent Application Publication
(10) Pub. No.: US 2026/0260455 A1
(43) Pub. Date: Sep. 3, 2026

(54) INTERACTION METHOD, APPARATUS, ELECTRONIC DEVICE, STORAGE MEDIUM, AND PROGRAM PRODUCT

(71) Applicant: Beijing Zitiao Network Technology Co., Ltd., Beijing (CN)

(72) Inventors: Youjia SHEN, Beijing (CN); Peixun ZHONG, Beijing (CN); Ziyang ZHENG, Beijing (CN)

(21) Appl. No.: 19/531,351

(22) Filed: Feb. 5, 2026

(30) Foreign Application Priority Data
Feb. 28, 2025 (CN) 202510232801.9

(51) Int. Cl. G06V 10/70; G06F 3/0482; G06V 20/40; H04N 23/63

(52) U.S. Cl. CPC G06V 10/70; G06F 3/0482; G06V 20/46; H04N 23/632

(57) ABSTRACT

The present disclosure relates to an interaction method and apparatus, an electronic device, a storage medium, and a program product, and relates to the field of artificial intelligence and computer technologies. The interaction method of the present disclosure includes: displaying one or more pieces of recommended demand information, in response to a user inputting visual media content, wherein the one or more pieces of recommended demand information are determined by understanding the visual media content and match the visual media content, and the one or more pieces of recommended demand information are configured for representing one or more intents for the visual media content; determining a work link corresponding to target recommended demand information, in response to a trigger operation of the user on the target recommended demand information from the one or more pieces of recommended demand information; and displaying answer content, wherein the answer content is generated based on the visual media content and the work link.

### CROSS-REFERENCE TO RELATED APPLICATIONS

This application claims the benefit under 35 USC 119(a) of Chinese Patent Application No. 202510232801.9, filed on Feb. 28, 2025. The entire disclosure of the prior application is incorporated herein by reference in its entirety.

### TECHNICAL FIELD

The present disclosure relates to the field of artificial intelligence and computer technologies, and in particular, to an interaction method and apparatus, an electronic device, a storage medium, and a program product.

### BACKGROUND

With the development of artificial intelligence (AI) technology, AI-based applications or agents may provide users with more and more diverse functions. For example, an application or an agent may generate text based on an image input by a user, generate a video, answer questions, etc.

### SUMMARY

According to some embodiments of the present disclosure, an interaction method is provided. The method includes: displaying one or more pieces of recommended demand information, in response to a user inputting visual media content, wherein the one or more pieces of recommended demand information are determined by understanding the visual media content and match the visual media content, and the one or more pieces of recommended demand information are configured for representing one or more intents for the visual media content; determining a work link corresponding to target recommended demand information, in response to a trigger operation of the user on the target recommended demand information from the one or more pieces of recommended demand information; and displaying answer content, wherein the answer content is generated based on the visual media content and the work link.

According to some further embodiments of the present disclosure, an electronic device is provided. The electronic device includes: a processor; and a memory coupled to the processor and configured to store instructions, where the instructions, when executed by the processor, cause the processor to perform the interaction method according to any embodiment of the present disclosure.

According to some still further embodiments of the present disclosure, a computer-readable storage medium is provided. The computer-readable storage medium has a computer program stored thereon, where the program, when executed by a processor, implements the interaction method according to any embodiment of the present disclosure.

According to some further embodiments of the present disclosure, a computer program product is provided. The computer program product includes: instructions, where the instructions, when executed by a processor, cause the processor to perform the interaction method according to any embodiment of the present disclosure.

Other features, aspects, and advantages of the present disclosure will become apparent through the following detailed description of exemplary embodiments of the present disclosure with reference to the drawings.

### BRIEF DESCRIPTION OF THE DRAWINGS

Embodiments of the present disclosure are explained hereunder with reference to the drawings. It is to be understood that the drawings in the following description relate to only some embodiments of the present disclosure and are not limiting of the present disclosure. In the drawings:

FIG. 1 is a schematic flowchart of an interaction method according to some embodiments of the present disclosure;

FIGS. 2 to 7 are schematic diagrams of interfaces according to some embodiments of the present disclosure;

FIG. 8 is a schematic diagram of a structure of an interaction apparatus according to some embodiments of the present disclosure;

FIG. 9 is a schematic diagram of a structure of an electronic device according to some embodiments of the present disclosure; and

FIG. 10 is a schematic diagram of a structure of an electronic device according to some other embodiments of the present disclosure.

### DETAILED DESCRIPTION

The technical solutions in the embodiments of the present disclosure will be described clearly and comprehensively with reference to the drawings in the embodiments of the present disclosure. It is to be understood that the present disclosure may be implemented in various forms and should not be construed as limited to the embodiments set forth herein.

It is to be understood that the steps described in the method implementations of the present disclosure may be performed in different orders and/or in parallel. Furthermore, the method implementations may include additional steps and/or omit the steps shown. The scope of the present disclosure is not limited in this regard. Unless otherwise specified, the relative arrangement of steps set forth in these embodiments is to be construed as merely exemplary and does not limit the scope of the present disclosure.

The term “include/comprise” and variations thereof used in the present disclosure mean an open term that at least includes the following elements/features, but does not exclude other elements/features, that is, “include/comprise but not limited to”. The term “based on” means “at least partially based on”.

It is to be noted that concepts such as “first” and “second” mentioned in the present disclosure are only used to distinguish different apparatuses, modules, or units, and are not used to limit the order or interdependence of the functions performed by these apparatuses, modules, or units. Unless otherwise specified, concepts such as “first” and “second” are not intended to imply that the objects so described must be in a given order temporally, spatially, in ranking, or in any other way.

It is to be noted that the modifiers of “one” and “multiple” mentioned in the present disclosure are illustrative and not restrictive, and those skilled in the art should understand that they should be construed as “one or more” unless the context clearly indicates otherwise.

The names of messages or information exchanged between multiple apparatuses in the implementations of the present disclosure are for illustrative purposes only, and are not intended to limit the scope of these messages or information.

It is to be understood that the present disclosure also does not limit how to obtain the image to be applied/processed. In some embodiments of the present disclosure, the image may be obtained from a storage apparatus such as an internal memory or an external storage apparatus. In some other embodiments of the present disclosure, a photographing component may be mobilized to take a picture. It should be noted that the obtained image may be a captured image or a frame of image in a captured video, which is not particularly limited thereto.

In the context of the present disclosure, an image may refer to any of a variety of images, such as a color image, a grayscale image, etc. It should be pointed out that in the context of this specification, the type of the image is not specifically limited. Furthermore, the image may be any suitable image, such as an original image obtained by a photographing apparatus, or an image that has been subjected to specific processing on the original image, such as preliminary filtering, anti-aliasing, color adjustment, contrast adjustment, normalization, and the like. It should be pointed out that the pre-processing operation may also include other types of pre-processing operations known in the art, which will not be described in detail here.

The embodiments of the present disclosure are described in detail hereunder with reference to the drawings, but the present disclosure is not limited to these specific embodiments. The following specific embodiments may be combined with each other, and the same or similar concepts or processes may not be described in detail in some embodiments. Furthermore, in one or more embodiments, specific features, structures, or characteristics may be combined in any suitable manner that will be clear to those of ordinary skill in the art from this disclosure.

At present, some applications or agents may provide users with various processing functions for images. However, if a user wants to use a certain function, it is necessary to input a corresponding instruction (prompt information). For example, if the user desires to beautify an image, it is necessary to input an instruction to instruct to beautify the image, such as “please help retouch the picture”. In many cases, the manner of inputting instructions to invoke specific processing functions makes users feel cumbersome and inefficient, and it is difficult for users to accurately express instructions, making it difficult for the image processing results to meet the needs of users.

Based on the above problems, the present disclosure provides an interaction method. In the method, in response to a user inputting visual media content, one or more pieces of recommended demand information matching the visual media content are determined by understanding the visual media content, and the one or more pieces of recommended demand information are displayed. The one or more pieces of recommended demand information are configured for representing one or more intents for the visual media content. Since the one or more pieces of recommended demand information are determined based on the understanding of the visual media content, the one or more pieces of recommended demand information are closer to the real needs of the user, which facilitates the user to quickly locate target recommended demand information, and the one or more pieces of recommended demand information are dynamically adjusted and changed for different visual media content. In response to a trigger operation of the user on the target recommended demand information from the one or more pieces of recommended demand information, a work link corresponding to the target recommended demand information is determined, and then answer content is generated and displayed based on the visual media content and the work link. In the entire interaction process, the user does not need to input instructions by himself/herself, and only needs to trigger the target recommended demand information to obtain the answer content, which improves the interaction efficiency from the visual media content to the answer content. Furthermore, the corresponding work link is invoked based on the target recommended demand information to generate the answer content, which improves the accuracy and efficiency of generating the answer content.

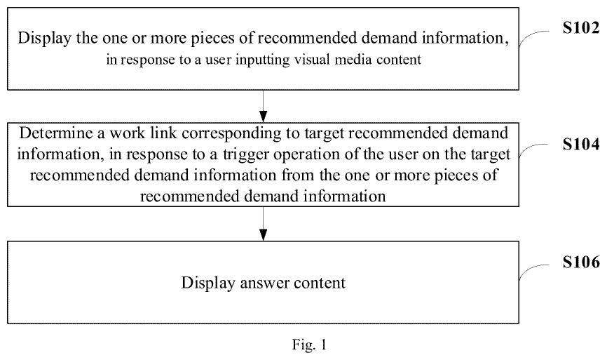

The interaction method of the present disclosure is described hereunder with reference to FIGS. 1 to 7. The interaction method of the present disclosure may be performed by at least one of an application, an agent, a robot (Bot), an apparatus for generating multimedia content, and an electronic device, but is not limited to the examples shown.

FIG. 1 is a flowchart of some embodiments of an interaction method of the present disclosure. As shown in FIG. 1, the method in these embodiments includes steps S102 to S106.

In step S102, one or more pieces of recommended demand information are displayed, in response to a user inputting visual media content.

For example, a user may input visual media content in an interaction interface, and the interaction interface may be an interaction interface provided by an application, an agent, a robot, an apparatus for generating multimedia content, or an electronic device, etc. The visual media content may be acquired from an internal storage apparatus or an external storage apparatus of an electronic device (e.g., a terminal) used by the user, or may be captured by invoking a photographing component in the electronic device used by the user, which is not limited to the examples shown.

For example, the visual media content includes content that conveys information through a visual channel, such as an image or a video. For example, a machine learning model may be used to understand the visual media content, and determine one or more pieces of recommended demand information matching the visual media content. For different visual media content, the determined one or more pieces of recommended demand information may be different.

The one or more pieces of recommended demand information correspond to one or more achievable functions. The recommended demand information may be understood as an instruction recommended to the user. The user may select a piece of recommended demand information from the one or more pieces of recommended demand information as an instruction (or prompt information) to instruct an application, an agent, etc. to perform corresponding processing. The one or more pieces of recommended demand information are used for representing one or more intents for the visual media content, that is, the one or more pieces of recommended demand information may represent one or more intents of the user predicted based on the visual media content.

For example, the one or more pieces of recommended demand information may include different types of recommended demand information, which may include recommended demand information for modifying the visual media, recommended demand information for asking a question about the visual media content, recommended demand information for generating reply information based on the visual media content and feeding back the reply information in the visual media content, etc., which is not limited to the examples shown. The different types of recommended demand information may be further divided, which will be described in subsequent embodiments.

The visual media content input by the user may be displayed in the interaction interface or a preview interface. The one or more pieces of recommended demand information may be displayed in the interaction interface or the preview interface. The one or more pieces of recommended demand information may be interactive elements in the form of controls, items, or menus, etc., which is not limited to the examples shown. The display interface and display manner of the one or more pieces of recommended demand information are not limited to the examples shown.

In step S104, in response to a trigger operation of the user on target recommended demand information from the one or more pieces of recommended demand information, a work link corresponding to the target recommended demand information is determined.

The user may trigger the target recommended demand information through an operation such as clicking or selecting. The work link corresponding to the target recommended demand information may include one or more work nodes, and the one or more work nodes include at least one of a model, an application, a plug-in, and an agent. Different types of target recommended demand information may correspond to different work links.

In step S106, answer content is displayed, wherein the answer content is generated based on the visual media content and the work link.

The one or more work nodes in the work link may be used to process the visual media content according to a work sequence, and finally generate the answer content for the target recommended demand information. The answer content may be displayed in the interaction interface, may be displayed in the visual media content, or may be displayed in various forms, which is not limited to the examples shown.

In the interaction method in the above embodiments, in response to a user inputting visual media content, one or more pieces of recommended demand information matching the visual media content are determined by understanding the visual media content, and the one or more pieces of recommended demand information are displayed. The one or more pieces of recommended demand information are used for representing one or more intents for the visual media content. Since the one or more pieces of recommended demand information are determined based on the understanding of the visual media content, the one or more pieces of recommended demand information are closer to the real needs of the user, which facilitates the user to quickly locate target recommended demand information, and the one or more pieces of recommended demand information are dynamically adjusted and changed for different visual media content. In response to a trigger operation of the user on the target recommended demand information from the one or more pieces of recommended demand information, a work link corresponding to the target recommended demand information is determined, and then answer content is generated and displayed based on the visual media content and the work link. In the entire interaction process, the user does not need to input instructions by himself/herself, and only needs to trigger the target recommended demand information to obtain the answer content, which improves the interaction efficiency from the visual media content to the answer content. Furthermore, the corresponding work link is invoked based on the target recommended demand information to generate the answer content, which improves the accuracy and efficiency of generating the answer content.

Furthermore, displaying the one or more pieces of recommended demand information based on the understanding of the visual media content is more in line with the intents and needs of the user than fixedly displaying some recommended demand information, which improves the effectiveness of the recommended demand information, and also enables the user to locate the target recommended demand information more quickly.

Hereunder is described how the user inputs the visual media content, how to trigger the understanding of the visual media content to determine the one or more pieces of recommended demand information matching the visual media content, and how to display the one or more pieces of recommended demand information.

In some embodiments, a camera control is displayed; a preview interface is displayed in response to a user triggering the camera control; and in response to the user completing a photographing operation for the visual media content, the visual media content is understood, and one or more pieces of recommended demand information matching the visual media content are determined, where the one or more pieces of recommended demand information are displayed in the preview interface.

For example, the camera control may be displayed in an interaction interface, and the user may display the preview interface by triggering the camera control in the interaction interface, and an image captured by a camera lens may be displayed in the preview interface. A photographing control may be displayed in the preview interface, and the user may photograph the visual media content by triggering the photographing control. In response to the user completing photographing of the visual media content, the visual media content may be displayed in the preview interface.

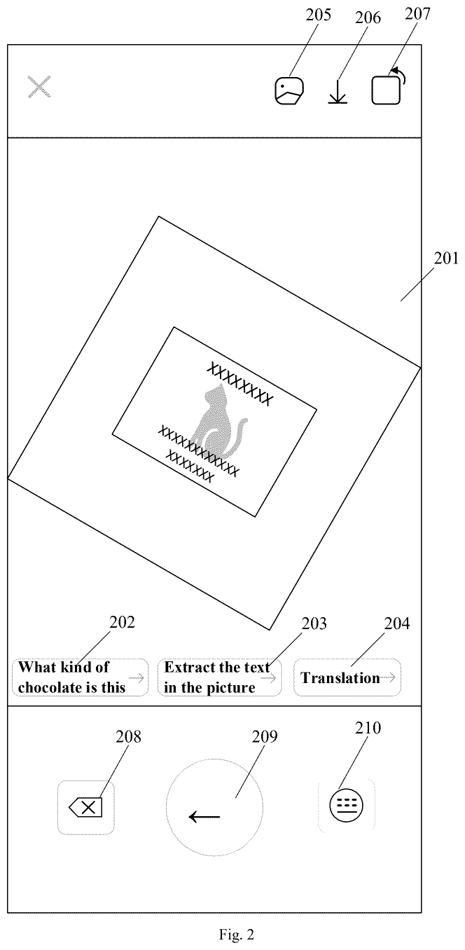

The one or more pieces of recommended demand information may also be displayed in the photographing preview interface. As shown in FIG. 2 which is a preview interface, an image (visual media content) 201 and multiple pieces of recommended demand information 202 to 204 may be displayed. As shown in FIG. 2, a selection control 205 may also be displayed in the preview interface. In response to the user triggering the selection control 205, multiple pieces of candidate visual media content may be displayed. In response to a selection operation of the user on a piece of visual media content from the multiple pieces of candidate visual media content, the selected visual media content is displayed in the preview interface. A download control 206 may also be displayed in the preview interface, which may be used for downloading the visual media content. The preview interface may also include a rotation control 207, which may be used for rotating the visual media content by a specific angle for display. The preview interface may also include a rollback control 208, which is used for cancelling display of the current visual media content and re-displaying the image captured by the camera lens. The preview interface may also include an input control 210. In response to the user triggering the input control 210, an input area is displayed. In response to the user inputting prompt information in the input area and confirming, reply information is generated and displayed based on the visual media content and the prompt information. The user may also choose to input the prompt information (or an instruction) by himself/herself to trigger the processing of the visual media content.

According to the method in the above embodiments, the user may directly photograph the visual media content, and the one or more pieces of recommended demand information are automatically determined and displayed without the need for the user to input instructions, which improves the display efficiency of the one or more pieces of recommended demand information and improves the user experience.

In some embodiments, a selection control is displayed; one or more pieces of candidate visual media content are displayed in response to a user triggering the selection control; and in response to a selection of visual media content by the user from the one or more pieces of candidate visual media content, the visual media content is displayed in a preview interface, the visual media content is understood, and one or more pieces of recommended demand information matching the visual media content are determined, where the one or more pieces of recommended demand information are displayed in the preview interface.

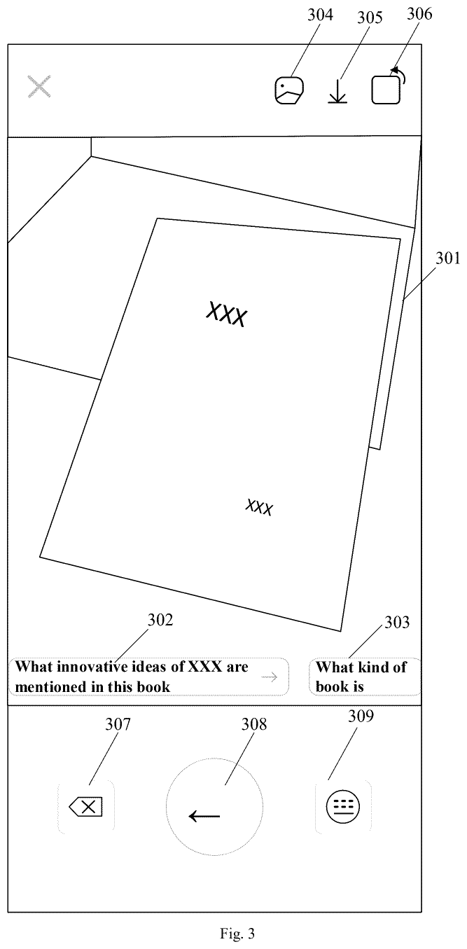

For example, the selection control may be displayed in the interaction interface, or the selection control may be displayed in the preview interface. As shown in FIG. 3 which is a preview interface, an image (visual media content) 301 and multiple pieces of recommended demand information 302 to 303 may be displayed. As shown in FIG. 3, a selection control 304 may also be displayed in the preview interface, which may be used for re-selecting the visual media content. A download control 305 may also be displayed in the preview interface, which may be used for downloading the visual media content. The preview interface may also include a rotation control 306, which may be used for rotating the visual media content by a specific angle for display. The preview interface may also include a rollback control 307, which is used for cancelling display of the current visual media content and re-displaying the multiple pieces of candidate visual media content. The preview interface may also include an input control 309. In response to the user triggering the input control 309, an input area is displayed. In response to the user inputting prompt information in the input area and confirming, reply information is generated and displayed based on the visual media content and the prompt information.

According to the method in the above embodiments, the user may select the existing visual media content, and the one or more pieces of recommended demand information are automatically determined and displayed without the need for the user to input instructions, which improves the display efficiency of the one or more pieces of recommended demand information and improves the user experience. The user may input the visual media content in different manners, which is convenient for the user.

In addition to displaying one or more pieces of visual media content in the preview interface, the one or more pieces of visual media content may also be displayed in the interaction interface. In some embodiments, a confirmation control is displayed in the preview interface; and in response to a user triggering the confirmation control, the interaction interface is displayed, and the one or more pieces of recommended demand information are displayed in the interaction interface.

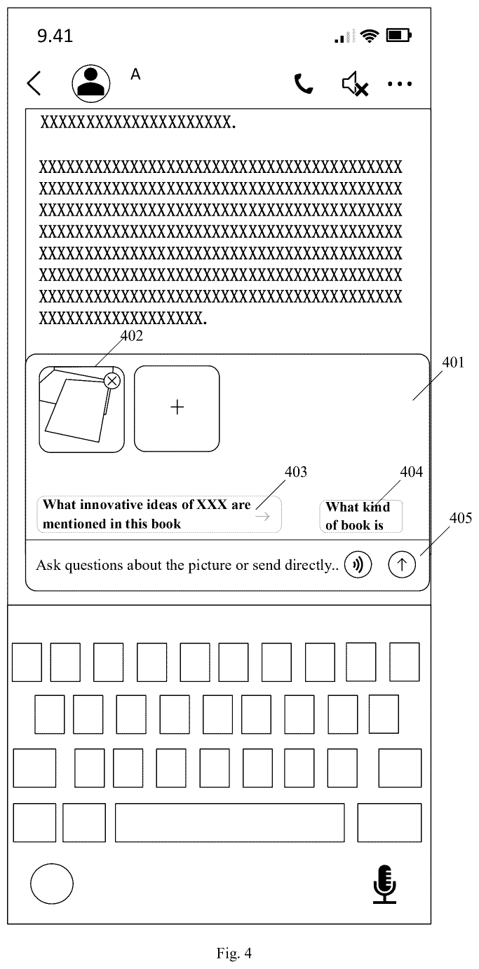

As shown in FIG. 2, the confirmation control 209 is displayed in the preview interface, and as shown in FIG. 3, the confirmation control 308 is displayed in the preview interface. For example, in response to the user triggering the confirmation control 308, the interaction interface shown in FIG. 4 may be displayed. Multiple pieces of recommended demand information 403 and 404 may be displayed in the interaction interface. The recommended demand information displayed in the interaction interface may be the same or different from that in the preview interface. As shown in FIG. 4, a thumbnail 402 of the visual media content may be displayed in an input display area, and multiple pieces of recommended demand information 403 and 404 may be displayed in the input display area. An input box 405 may also be displayed in the input display area, and the prompt information (or instruction) input by the user may be displayed in the input box 405. After the confirmation control 209 is triggered, an interaction interface similar to that in FIG. 4 may be displayed, which will not be described herein again.

The one or more pieces of recommended demand information may be displayed in multiple distribution scenarios on multiple interfaces, which improves the operation convenience for the user to select the recommended demand information, and by setting multiple display and interaction forms, it is convenient for the user to use different interaction manners to trigger the processing of the visual media content.

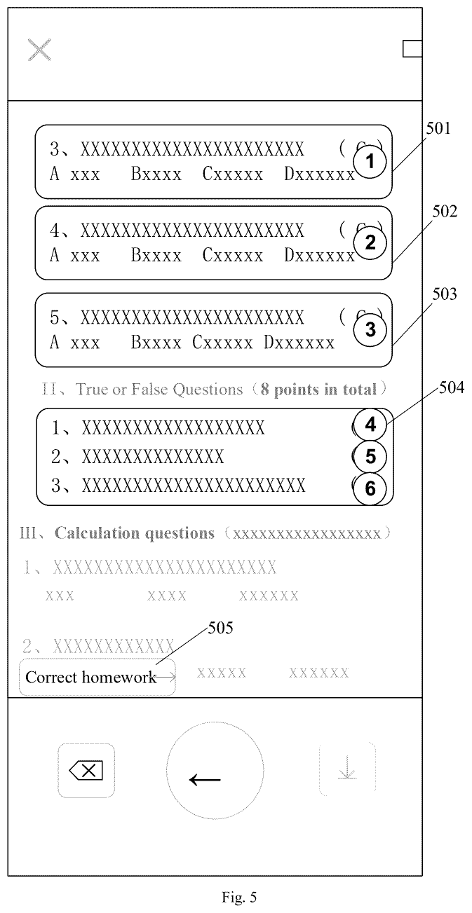

In addition to the visual media content and the one or more pieces of recommended demand information, annotation information for content related to the one or more pieces of recommended demand information may also be displayed in the preview interface. As shown in FIG. 5, annotation information 501 to 504 for multiple questions in an image and recommended demand information 505 are displayed in the preview interface.

By displaying the annotation information, the user may more clearly and intuitively determine the recognition result of the visual media content and the association between the recommended demand information and the visual media content, thereby improving the display effect.

After the visual media content input by the user is received, the visual media content is understood, and the one or more pieces of recommended demand information matching the visual media content are determined. How to determine the one or more pieces of recommended demand information is described below with reference to some embodiments.

In some embodiments, the visual media content is understood by a machine learning model, and at least one of an entity or a scene in the visual media content is determined; and the one or more pieces of recommended demand information matching the visual media content are determined based on the at least one of the entity or the scene.

The entity and the scene in the visual media content are main elements, and for visual media content including different types of entities, the needs of the user may be different. For example, for visual media content including a person, the user may prefer to beautify the visual media content, for visual media content including an item, the user may prefer to ask a question about the item, and for visual media content including text, the user may prefer to process the text. For visual media content including different types of scenes, the needs of the user may also be different. For example, for a landscape scene, the user may prefer to generate matching text, and for an indoor scene, the user may prefer to recognize and ask a question about an item in the scene, which is not limited to the examples shown.

For example, one or more pieces of recommended demand information matching the entity type may be determined, and/or one or more pieces of recommended demand information matching the scene type may be determined.

In the method in the above embodiments, at least one of the entity or the scene in the visual media content is determined by understanding the visual media content, and then the one or more pieces of recommended demand information are determined, which may improve the accuracy of determining the one or more pieces of recommended demand information.

In some embodiments, the visual media content is understood by a machine learning model, and at least one of an entity or a scene in the visual media content is determined; and one or more pieces of recommended demand information are determined from first-type recommended demand information, second-type recommended demand information, and third-type recommended demand information based on the at least one of the entity or the scene, where the first-type recommended demand information includes recommended demand information for modifying the visual media content, the second-type recommended demand information includes recommended demand information for asking a question about the visual media content, and the third-type recommended demand information includes recommended demand information for generating reply information based on the visual media content and feeding back the reply information in the visual media content.

Different types of recommended demand information (or recommended instructions) may be divided based on specific processing manners for the visual media content. The first-type and second-type recommended demand information may be further divided. For example, the first-type recommended demand information may be further divided, based on the modification manner, into recommended demand information for modifying the visual media content based on one or more specific beautification manners, generating another type of visual media content based on a current type of visual media content, and the like. For example, the one or more specific beautification manners include a combination of one or more of: beautifying a person, adding a filter, changing a painting style, adding an effect, changing colors, and the like, which is not limited to the examples shown. For example, the current type of visual media content is an image, and the another type of visual media content to be generated is a video.

For example, the second-type recommended demand information may be further divided into recommended demand information for asking a question associated with the entity in the visual media content, asking a question associated with the scene in the visual media content, asking to generate specific text based on the visual media content, asking to generate music based on the visual media content, and the like, which is not limited to the examples shown.

The type of the one or more pieces of recommended demand information may be determined based on at least one of the entity or the scene in the visual media content. For example, in response to determining that the entity in the visual media content includes a person, one or more pieces of recommended demand information are determined from the first-type recommended demand information. For example, in response to determining that the entity in the visual media content includes at least one of food, an item, an animal, a plant, and a building, one or more pieces of recommended demand information are determined from the second-type recommended demand information. For example, in response to determining that the entity in the visual media content includes a character, one or more pieces of recommended demand information are determined from the third-type recommended demand information. For example, in response to determining that the scene in the visual media content is a landscape, one or more pieces of recommended demand information are determined from the first-type recommended demand information and the second-type recommended demand information. For example, in response to determining that the scene in the visual media content is a learning scene and the entity includes a character, one or more pieces of recommended demand information are determined from the third-type recommended demand information. Specifically, the type of the one or more pieces of recommended demand information and the specific one or more pieces of recommended demand information may be determined by understanding the visual media content through the machine learning model, which is not limited to the examples shown above.

After the type of the one or more pieces of recommended demand information is determined, the one or more pieces of recommended demand information may be determined based on at least one of the entity or the scene in the visual media content.

For example, as shown in FIG. 2, by understanding the image, determining that the entity is an item, and recognizing that the item is chocolate, the second-type recommended demand information may be determined, and it is determined that the recommended demand information is “what kind of chocolate is this”. By recognizing that the item has text, the third-type recommended demand information may be determined, and it is determined that the recommended demand information is “translation”, which implicitly means that the translated text is directly displayed in the image. In response to the user selecting “translation”, the prompt information may be sent to the work chain, for example, the prompt information may indicate “translate the text in the image and display the translated text in the position corresponding to the original text in the image”. As shown in FIG. 3, by understanding the image, determining that the entity is a book, and recognizing a person involved in the book, the second-type recommended demand information may be determined, and it is determined that the recommended demand information is “what innovative ideas of XXX are mentioned in the book” and “what kind of book is this”.

In the method in the above embodiments, at least one of the entity or the scene in the visual media content is determined by understanding the visual media content, and then one or more pieces of recommended demand information are determined from the first-type recommended demand information, the second-type recommended demand information, and the third-type recommended demand information, which may improve the accuracy of determining the recommended demand information, and different types of recommended demand information may be determined for different visual media content, thereby improving the degree of matching between the recommended demand information and the visual media content, and better meeting the needs of the user.

In some embodiments, the visual media content includes multiple images, and the at least one of the entity or the scene in the visual media content comprises at least one of an entity or a scene of each image of the multiple images; and the determining one or more pieces of recommended demand information from first-type recommended demand information, second-type recommended demand information, and third-type recommended demand information based on the at least one of the entity or the scene includes: determining a theme and key elements of the multiple images based on the at least one of the entity or the scene of each image; and determining the one or more pieces of recommended demand information from the first-type recommended demand information, the second-type recommended demand information, and the third-type recommended demand information based on the theme and the key elements of the multiple images.

The visual media content may include multiple images, and a theme and key elements need to be determined for the multiple images. The key elements may be entities, scenes, features related to the entities, and/or features related to the scenes. For example, it is determined that the theme of the multiple images is a set of fitness actions, and the key elements include the actions of a person. Furthermore, the second-type recommended demand information may be determined, for example, the recommended demand information is “what is the function of this set of fitness actions” and “what should be paid attention to during training”.

In the method in the above embodiments, in the case of the multiple images, the multiple images are understood in an association manner, the theme and the key elements of the multiple images are extracted, and then the one or more pieces of recommended demand information are determined from the first-type recommended demand information, the second-type recommended demand information, and the third-type recommended demand information, which may provide the one or more pieces of recommended demand information for the user for the multiple images as a whole, thereby improving the degree of matching between the determined recommended demand information and the multiple images, and improving the accuracy of determining the recommended demand information.

In some embodiments, the visual media content includes a video, and the at least one of the entity or the scene in the visual media content includes at least one of an entity or a scene of a key frame in the video; and determining the one or more pieces of recommended demand information from the first-type recommended demand information, the second-type recommended demand information, and the third-type recommended demand information based on the at least one of the entity or the scene includes: determining a theme and key elements of the video based on the at least one of the entity or the scene of the key frame; and determining the one or more pieces of recommended demand information from the first-type recommended demand information, the second-type recommended demand information, and the third-type recommended demand information based on the theme and the key elements of the video.

The visual media content may include a video, a key frame of the video is determined, at least one of an entity or a scene in each key frame is recognized, and then a theme and key elements of the video are determined. The one or more pieces of recommended demand information are determined from the first-type recommended demand information, the second-type recommended demand information, and the third-type recommended demand information based on the theme and the key elements of the video. The key elements may be entities, scenes, features related to the entities, and/or features related to the scenes. For example, if the theme of the video is a makeup tutorial and key elements are cosmetics used by a person in the video, the second-type recommended demand information may be determined, and the recommended demand information may be “names and models of the cosmetics” and the like.

In the method in the above embodiments, for the video input by the user, the theme and the key elements of the video may be determined according to the entity and the scene of the key frame, and then the one or more pieces of recommended demand information are determined from the first-type recommended demand information, the second-type recommended demand information, and the third-type recommended demand information, which may provide the one or more pieces of recommended demand information for the user for the video as a whole, thereby improving the degree of matching between the determined recommended demand information and the video, and improving the accuracy of determining the recommended demand information.

In each of the above embodiments, the one or more pieces of recommended demand information are mainly determined based on the visual media content itself, and the one or more pieces of recommended demand information may also be determined with reference to the user's historical interaction information and behavior habit.

In some embodiments, understanding the visual media content and determining the one or more pieces of recommended demand information matching the visual media content include: determining the one or more pieces of recommended demand information matching the visual media content based on at least one of historical interaction information corresponding to the user or a behavior habit of the user, and understanding of the visual media content.

For example, semantic understanding is performed on the user's historical interaction information to determine whether there is information associated with the visual media content, and the one or more pieces of recommended demand information are determined based on the associated information and the understanding of the visual media content. For example, the user mentions that he/she likes traveling in the historical interaction information, and in the case that the image input by the user is a landscape photo, the recommended demand information may be “where is this” and “make a travel guide”.

For example, the user's behavior habit includes a type of recommended demand information historically selected by the user, at least one of an entity or a scene of visual media content corresponding to the recommended demand information historically selected by the user. For some visual media content, the user may prefer to select a certain type of recommended demand information, and the one or more pieces of recommended demand information may be determined based on the user's behavior habit in combination with the understanding of the visual media content.

In the method in the above embodiments, at least one of the user's historical interaction information or behavior habit is referred to, and the one or more pieces of recommended demand information are determined in combination with the understanding of the visual media content, which is closer to the real intention of the user, thereby improving the accuracy and effectiveness of determining the recommended demand information.

How to determine the work link corresponding to the target recommended demand information is described below with reference to some embodiments.

In some embodiments, determining the work link corresponding to the target recommended demand information includes: understanding the target recommended demand information, and determining one or more work nodes required for generating the answer content corresponding to the target recommended demand information and a sequence of the one or more work nodes, where the one or more work nodes include at least one of a model, an application, a plug-in, or an agent; and determining the work link based on the one or more work nodes and the sequence of the one or more work nodes.

In order to allow the user to better understand the recommended demand information, the displayed recommended demand information is usually relatively short. Each piece of recommended demand information may correspond to prompt information. For example, the recommended demand information is “translation”, and the corresponding prompt information is “translate the text in the image and display the translated text in the position corresponding to the original text in the image”. Therefore, understanding the target recommended demand information may be understanding the prompt information corresponding to the target recommended demand information.

The target recommended demand information may be understood using a machine learning model to determine the one or more work nodes required for generating the answer content corresponding to the target recommended demand information and the sequence of the one or more work nodes. The work nodes may be in different forms and need to be determined according to a specific manner of generating the answer content.

In the method in the above embodiments, the work link may be dynamically generated in real time for different pieces of target recommended demand information, which improves the accuracy of determining the work link and further improves the accuracy of generating the reply content.

How to determine the one or more work nodes for different types of the target recommended demand information is described below.

In some embodiments, understanding the target recommended demand information, and determining the one or more work nodes required for generating the answer content corresponding to the target recommended demand information includes: in response to the target recommended demand information being first-type recommended demand information, determining that the one or more work nodes include a visual understanding node and a modification node, where the visual understanding node is configured to understand the visual media content to obtain understanding information, and the modification node is configured to modify the visual media content based on the understanding information and the target recommended demand information.

The target recommended demand information is the first-type recommended demand information, that is, the target recommended demand information is recommended demand information for modifying the visual media content. In the process of generating the answer content based on the visual media content and the work link, the visual media content may be input into the visual understanding node to obtain the understanding information, and the understanding information may be further input into the modification node to modify the visual media content based on the understanding information and the target recommended demand information. The modification node may be different for different modification manners. For example, a modification node for beautifying an image is different from a modification node for generating a video based on an image.

In the method in the above embodiments, in the case that the user selects to modify the visual media content, it may be determined that the work link includes the visual understanding node and the modification node, so that the work link may accurately modify the visual media content, thereby improving the accuracy of the answer content.

In some embodiments, understanding the target recommended demand information, and determining the one or more work nodes required for generating the answer content corresponding to the target recommended demand information includes: in response to the target recommended demand information being the second-type recommended demand information, determining that the one or more work nodes include a visual understanding node, a search node, and a generation node, where the visual understanding node is configured to understand the visual media content to obtain understanding information, the search node is configured to search for information related to a question about the visual media content based on the understanding information and the target recommended demand information, and the generation node is configured to generate an answer based on the information related to the question about the visual media content.

The target recommended demand information is the second-type recommended demand information, that is, the target recommended demand information is recommended demand information for asking a question about the visual media content. The one or more work nodes may also include only the visual understanding node and the search node, or only the visual understanding node and the generation node. For example, the target recommended demand information is asking a question associated with an entity in the visual media content or asking a question associated with a scene in the visual media content, and the plurality of work nodes may include only the visual understanding node and the search node. For example, the target recommended demand information is recommended demand information for asking a question about generating specific text based on the visual media content or asking a question about generating music based on the visual media content, and the plurality of work nodes may include only the visual understanding node and the generation node. The generation node is configured to generate the answer based on the target recommendation information and the understanding information.

In the process of generating the answer content based on the visual media content and the work link, the visual media content may be input into the visual understanding node to obtain the understanding information, the understanding information may be further input into the search node to obtain the information related to the question about the visual media content, and the information related to the question about the visual media content may be input into the generation node to generate the answer. For example, as shown in FIG. 2, the image includes chocolate, and the target recommended demand information is “what kind of chocolate is this”, information related to the chocolate may be searched based on the understanding information, and then a name and introduction information of the chocolate may be obtained, and the answer content may be generated based on the name and introduction information of the chocolate.

In the method in the above embodiments, in the case that the user selects to ask a question about the visual media content, it may be determined that the work link includes the visual understanding node, the search node, and the generation node, so that the work link may accurately answer the question about the visual media content, thereby improving the accuracy of the answer content.

In some embodiments, in response to the target recommended demand information being third-type recommended demand information, it is determined that the one or more work nodes include a visual understanding node, a reply information determination node, and an addition node, where the visual understanding node is configured to understand the visual media content to obtain understanding information, the reply information determination node is configured to determine reply information based on the understanding information and the target recommended demand information, and the addition node is configured to add the reply information to the visual media content.

The target recommended demand information is the third-type recommended demand information, that is, the target recommended demand information is recommended demand information for generating reply information based on the visual media content and feeding back the reply information in the visual media content. In the process of generating the answer content based on the visual media content and the work link, the visual media content may be input into the visual understanding node to obtain the understanding information, the understanding information may be further input into the reply information determination node to determine the reply information, and the reply information is input into the addition node to be added to the visual media content.

For example, the reply information determination node may be a search node, a generation node, a translation node, etc., which needs to be determined based on the target recommended demand information. For example, if the target recommended demand information is “translation”, the reply information determination node is the translation node, and if the target recommended demand information is “correct homework”, the reply information determination node is the search node and/or the generation node.

In the method in the above embodiments, in the case that the user selects the recommended demand information for generating the reply information based on the visual media content and feeding back the reply information in the visual media content, it may be determined that the work link includes the visual understanding node, the reply information determination node, and the addition node, so that the work link may accurately generate the reply information and add the reply information to the visual media content, thereby improving the accuracy of the answer content.

How to generate the answer content and display the answer content is described below.

In some embodiments, generating the answer content based on the visual media content and the work link, and displaying the answer content includes at least one of: in response to the target recommended demand information being the first-type recommended demand information, generating modified visual media content based on the visual media content and the work link, and displaying the modified visual media content in the interaction interface; in response to the target recommended demand information being the second-type recommended demand information, generating an answer to a question about the visual media content based on the visual media content and the work link, and displaying the answer in the interaction interface; or in response to the target recommended demand information being the third-type recommended demand information, generating reply information corresponding to the visual media content based on the visual media content and the work link, and adding the reply information to the visual media content and displaying the reply information in the visual media content.

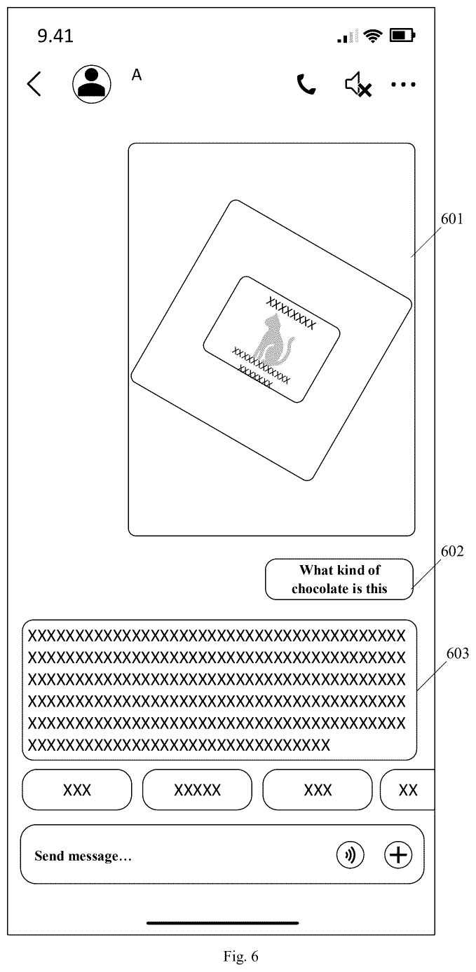

The modified visual media content and the answer may be directly displayed in the interaction interface. For example, as shown in FIG. 2, in response to the recommended demand information 202 “what kind of chocolate is this” selected by the user, the interaction interface shown in FIG. 6 may be displayed. An image 601, recommended demand information 602, and answer content 603 are displayed in the interaction interface.

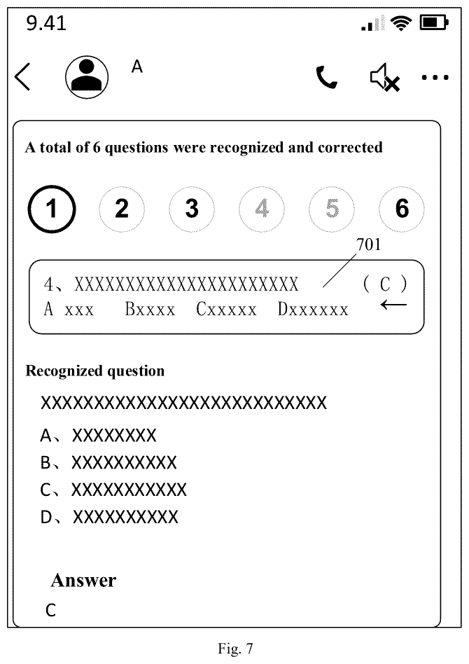

The reply information may also be added to and displayed in the visual media content. For example, as shown in FIG. 5, in response to the recommended demand information 505 “correct homework” selected by the user, the interaction interface shown in FIG. 7 may be displayed. As shown in FIG. 7, the visual media content added with the reply information may be displayed in the interaction interface, the visual media content is 701, and other content is the reply information added to the visual media content, such as a check mark, a question number, content related to a recognized question, and an answer.

For different types of target recommended demand information, different work links are used to generate the answer content, and different display manners are used for display, which may present better visual effects for the user, and facilitate the user to locate, view and understand the answer content.

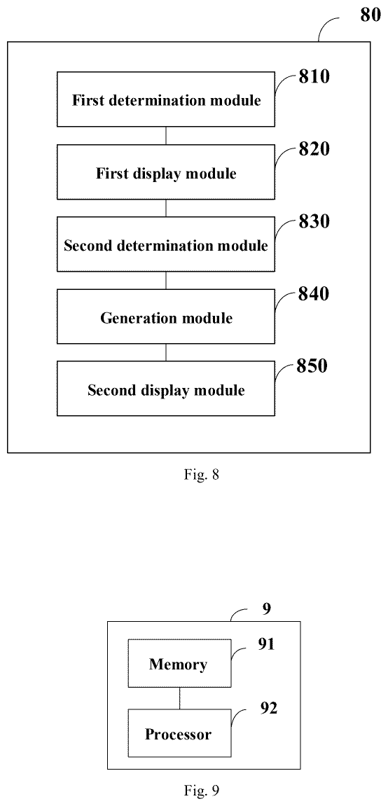

The present disclosure further provides an interaction apparatus, which is described below with reference to FIG. 8.

FIG. 8 is a structural diagram of some embodiments of an interaction apparatus of the present disclosure. As shown in FIG. 8, the interaction apparatus 80 in this embodiment includes: a first determination module 810, a first display module 820, a second determination module 830, a generation module 840, and a second display module 850.

The first determination module 810 is configured to, in response to a user inputting visual media content, understand the visual media content, and determine one or more pieces of recommended demand information matching the visual media content, where the one or more pieces of recommended demand information are configured for representing one or more intents for the visual media content.

The first display module 820 is configured to display the one or more pieces of recommended demand information.

The second determination module 830 is configured to, in response to a trigger operation of the user on target recommended demand information from the one or more pieces of recommended demand information, determine a work link corresponding to the target recommended demand information.

The generation module 840 is configured to generate answer content based on the visual media content and the work link.

The second display module 850 is configured to display the answer content.

In the interaction apparatus in the above embodiments, in response to a user inputting visual media content, one or more pieces of recommended demand information matching the visual media content are determined by understanding the visual media content, and the one or more pieces of recommended demand information are displayed. The one or more pieces of recommended demand information are used for representing one or more intents for the visual media content. Since the one or more pieces of recommended demand information are determined based on the understanding of the visual media content, the one or more pieces of recommended demand information are closer to the real needs of the user, which facilitates the user to quickly locate target recommended demand information, and the one or more pieces of recommended demand information are dynamically adjusted and changed for different visual media content. In response to a trigger operation of the user on the target recommended demand information from the one or more pieces of recommended demand information, a work link corresponding to the target recommended demand information is determined, and then answer content is generated and displayed based on the visual media content and the work link. In the entire interaction process, the user does not need to input instructions by himself/herself, and only needs to trigger the target recommended demand information to obtain the answer content, which improves the interaction efficiency from the visual media content to the answer content. Furthermore, the corresponding work link is invoked based on the target recommended demand information to generate the answer content, which improves the accuracy and efficiency of generating the answer content.

In some embodiments, the second determination module 830 is configured to understand the target recommended demand information, and determine one or more work nodes required for generating the answer content corresponding to the target recommended demand information and a sequence of the one or more work nodes, where the one or more work nodes include at least one of a model, an application, a plug-in, or an agent; and determine the work link based on the one or more work nodes and the sequence of the one or more work nodes.

In some embodiments, the first determination module 810 is configured to use a machine learning model to understand the visual media content, and determine at least one of an entity or a scene in the visual media content; and determine one or more pieces of recommended demand information from first-type recommended demand information, second-type recommended demand information, and third-type recommended demand information based on the at least one of the entity or the scene, where the first-type recommended demand information includes recommended demand information for modifying the visual media content, the second-type recommended demand information includes recommended demand information for asking a question about the visual media content, and the third-type recommended demand information includes recommended demand information for generating reply information based on the visual media content and feeding back the reply information in the visual media content.

In some embodiments, the second determination module 830 is configured to, in response to the target recommended demand information being the first-type recommended demand information, determine that the one or more work nodes include a visual understanding node and a modification node, where the visual understanding node is configured to understand the visual media content to obtain understanding information, and the modification node is configured to modify the visual media content based on the understanding information and the target recommended demand information.

In some embodiments, the second determination module 830 is configured to, in response to the target recommended demand information being the second-type recommended demand information, determine that the one or more work nodes include a visual understanding node, a search node, and a generation node, where the visual understanding node is configured to understand the visual media content to obtain understanding information, the search node is configured to search for information related to a question about the visual media content based on the understanding information and the target recommended demand information, and the generation node is configured to generate an answer based on the information related to the question about the visual media content.

In some embodiments, the second determination module 830 is configured to, in response to the target recommended demand information being the third-type recommended demand information, determine that the one or more work nodes include a visual understanding node, a reply information determination node, and an addition node, where the visual understanding node is configured to understand the visual media content to obtain understanding information, the reply information determination node is configured to determine reply information based on the understanding information and the target recommended demand information, and the addition node is configured to add the reply information to the visual media content.

In some embodiments, the generation module 840 is configured to perform at least one of the following: in response to the target recommended demand information being the first-type recommended demand information, generating modified visual media content based on the visual media content and the work link, and displaying the modified visual media content in the interaction interface; in response to the target recommended demand information being the second-type recommended demand information, generating an answer to a question about the visual media content based on the visual media content and the work link, and displaying the answer in the interaction interface; or in response to the target recommended demand information being the third-type recommended demand information, generating reply information corresponding to the visual media content based on the visual media content and the work link, and adding the reply information to the visual media content and displaying the reply information in the visual media content.

In some embodiments, the first determination module 810 is configured to determine the one or more pieces of recommended demand information matching the visual media content based on at least one of historical interaction information corresponding to the user or a behavior habit of the user, and understanding of the visual media content.

In some embodiments, the visual media content includes multiple images, and the at least one of the entity or the scene in the visual media content includes at least one of an entity or a scene of each of the multiple images; and the first determination module 810 is configured to determine a theme and key elements of the multiple images based on the at least one of the entity or the scene of each image; and determine the one or more pieces of recommended demand information from the first-type recommended demand information, the second-type recommended demand information, and the third-type recommended demand information based on the theme and the key elements of the multiple images.

In some embodiments, the visual media content includes a video, and the at least one of the entity or the scene in the visual media content includes at least one of an entity or a scene of a key frame in the video; and the first determination module 810 is configured to determine a theme and key elements of the video based on the at least one of the entity or the scene of the key frame; and determine the one or more pieces of recommended demand information from the first-type recommended demand information, the second-type recommended demand information, and the third-type recommended demand information based on the theme and the key elements of the video.

In some embodiments, the first display module 820 is configured to display a camera control; and in response to the user triggering the camera control, display a preview interface; and the first determination module 810 is configured to, in response to the user completing a shooting operation on the visual media content, understand the visual media content, and determine the one or more pieces of recommended demand information matching the visual media content, where the one or more pieces of recommended demand information are displayed in the preview interface.

In some embodiments, the first display module 820 is configured to display a confirmation control in the preview interface; and in response to the user triggering the confirmation control, display the interaction interface, and display the one or more pieces of recommended demand information in the interaction interface.

In some embodiments, the first display module 820 is configured to display a selection control; and in response to the user triggering the selection control, display one or more pieces of candidate visual media content; and the first determination module 810 is configured to, in response to the user selecting the visual media content from the one or more pieces of candidate visual media content, display the visual media content in the preview interface, understand the visual media content, and determine the one or more pieces of recommended demand information matching the visual media content, where the one or more pieces of recommended demand information are displayed in the preview interface.

The present disclosure further provides an electronic device. The electronic device includes: a processor; and a memory coupled to the processor and configured to store instructions, where the instructions, when executed by the processor, cause the processor to perform the interaction method according to any embodiment of the present disclosure.

In the electronic device in the embodiments of the present disclosure, in response to a user inputting visual media content, one or more pieces of recommended demand information matching the visual media content are determined by understanding the visual media content, and the one or more pieces of recommended demand information are displayed. The one or more pieces of recommended demand information are used for representing one or more intents for the visual media content. Since the one or more pieces of recommended demand information are determined based on the understanding of the visual media content, the one or more pieces of recommended demand information are closer to the real needs of the user, which facilitates the user to quickly locate target recommended demand information, and the one or more pieces of recommended demand information are dynamically adjusted and changed for different visual media content. In response to a trigger operation of the user on the target recommended demand information from the one or more pieces of recommended demand information, a work link corresponding to the target recommended demand information is determined, and then answer content is generated and displayed based on the visual media content and the work link. In the entire interaction process, the user does not need to input instructions by himself/herself, and only needs to trigger the target recommended demand information to obtain the answer content, which improves the interaction efficiency from the visual media content to the answer content. Furthermore, the corresponding work link is invoked based on the target recommended demand information to generate the answer content, which improves the accuracy and efficiency of generating the answer content.

The present disclosure further provides a computer-readable storage medium having a computer program stored thereon, where the program, when executed by a processor, implements the interaction method according to any embodiment of the present disclosure.

In the computer-readable storage medium in the embodiments of the present disclosure, in response to a user inputting visual media content, one or more pieces of recommended demand information matching the visual media content are determined by understanding the visual media content, and the one or more pieces of recommended demand information are displayed. The one or more pieces of recommended demand information are used for representing one or more intents for the visual media content. Since the one or more pieces of recommended demand information are determined based on the understanding of the visual media content, the one or more pieces of recommended demand information are closer to the real needs of the user, which facilitates the user to quickly locate target recommended demand information, and the one or more pieces of recommended demand information are dynamically adjusted and changed for different visual media content. In response to a trigger operation of the user on the target recommended demand information from the one or more pieces of recommended demand information, a work link corresponding to the target recommended demand information is determined, and then answer content is generated and displayed based on the visual media content and the work link. In the entire interaction process, the user does not need to input instructions by himself/herself, and only needs to trigger the target recommended demand information to obtain the answer content, which improves the interaction efficiency from the visual media content to the answer content. Furthermore, the corresponding work link is invoked based on the target recommended demand information to generate the answer content, which improves the accuracy and efficiency of generating the answer content.

The present disclosure further provides a computer program product, including: instructions, where the instructions, when executed by a processor, cause the processor to perform the interaction method according to any embodiment of the present disclosure.

In the computer program product in the embodiments of the present disclosure, in response to a user inputting visual media content, one or more pieces of recommended demand information matching the visual media content are determined by understanding the visual media content, and the one or more pieces of recommended demand information are displayed. The one or more pieces of recommended demand information are used for representing one or more intents for the visual media content. Since the one or more pieces of recommended demand information are determined based on the understanding of the visual media content, the one or more pieces of recommended demand information are closer to the real needs of the user, which facilitates the user to quickly locate target recommended demand information, and the one or more pieces of recommended demand information are dynamically adjusted and changed for different visual media content. In response to a trigger operation of the user on the target recommended demand information from the one or more pieces of recommended demand information, a work link corresponding to the target recommended demand information is determined, and then answer content is generated and displayed based on the visual media content and the work link. In the entire interaction process, the user does not need to input instructions by himself/herself, and only needs to trigger the target recommended demand information to obtain the answer content, which improves the interaction efficiency from the visual media content to the answer content. Furthermore, the corresponding work link is invoked based on the target recommended demand information to generate the answer content, which improves the accuracy and efficiency of generating the answer content.

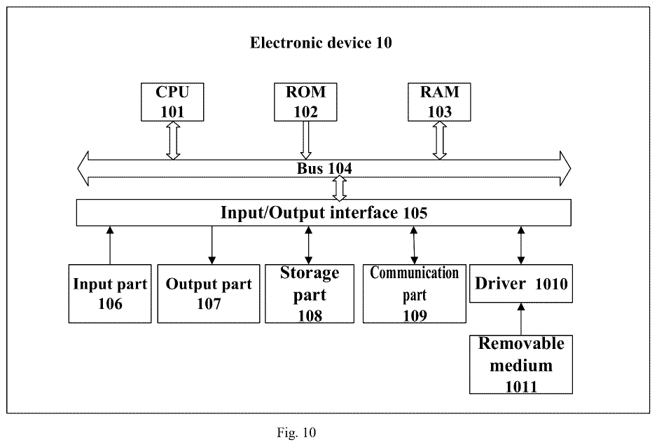

The electronic device of the present disclosure is described hereunder with reference to FIGS. 9 and 10.

FIG. 9 is a block diagram of an electronic device according to some embodiments of the present disclosure.

The memory 91 is used for storing one or more computer-readable instructions. The memory 91 may include any combination of various forms of computer-readable storage media, such as a volatile memory and/or a non-volatile memory, including but not limited to a random access memory (RAM), a dynamic random access memory (DRAM), a static random access memory (SRAM), a read-only memory (ROM), and a flash memory. The memory 91 may store, for example, an operating system, an application, a boot loader, a database, and other programs, and may also store various applications, various data, and the like.

The processor 92 is used for running the computer-readable instructions to implement the interaction method according to any of the embodiments. For the specific implementation of each step of the method, reference may be made to the above embodiments, and the repeated parts are not described herein.

The processor 92 may be embodied as various processing apparatuses, such as a central processing unit (CPU) and a network processor (NP); and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 92 and the memory 91 may directly or indirectly communicate with each other. For example, the processor 92 and the memory 91 may communicate through a network. The network may include a wireless network, a wired network, and/or any combination of a wireless network and a wired network. The processor 92 and the memory 91 may also communicate with each other through a system bus, which is not limited in the present disclosure.

It should be noted that the components of the electronic device 9 shown in FIG. 9 are only exemplary and non-restrictive, and the electronic device 9 may have other components according to actual application needs. The processor 92 may control other components in the electronic device 9 to perform desired functions.

The electronic device 9 may be implemented by software, firmware, and/or hardware, and may be integrated in an apparatus installed with relevant applications.

FIG. 10 is a block diagram of an electronic device according to some other embodiments of the present disclosure.

The electronic device 10 shown in FIG. 10 may be a computer system with a dedicated hardware structure, and may perform corresponding functions when installed with relevant applications.

The electronic device includes, but is not limited to, mobile terminals such as a smart phone, a notebook computer, a personal digital assistant (PDA), a tablet computer, a portable media player (PMP), a vehicle-mounted terminal (e.g., a vehicle navigation terminal), and a wearable device, and fixed terminals such as a digital television and a desktop computer.

As shown in FIG. 10, a central processing unit (CPU) 101 performs various processes according to a program stored in a read-only memory (ROM) 102 or a program loaded from a storage part 108 into a random access memory (RAM) 103. In the RAM 103, data required when the CPU 101 performs various processes and the like is stored as needed. The central processing unit is only exemplary, and it may also be other types of processors, such as various processors as described above. The ROM 102, the RAM 103, and the storage part 108 may be various forms of computer-readable storage media. It should be noted that although the ROM 102, the RAM 103, and the storage part 108 are shown separately in FIG. 10, one or more of them may be combined or located in the same or different memories or storage modules.

The CPU 101, the ROM 102, and the RAM 103 are connected to each other via a bus 104. An input/output interface 105 is also connected to the bus 104.

The following components are connected to the input/output interface 105: an input part 106 such as a touch screen, a touchpad, a keyboard, a mouse, an image sensor, a microphone, an accelerometer, and a gyroscope; an output part 107 including a display such as a cathode ray tube (CRT) and a liquid crystal display (LCD), a speaker, a vibrator, etc.; the storage part 108 including a hard disk, a magnetic tape, etc.; and a communication part 109 including a network interface card such as a LAN card and a modem. The communication part 109 allows communication processing to be performed via a network such as the Internet. It is easy to understand that although the components in the electronic device 10 are shown to communicate through the bus 104 in FIG. 10, they may also communicate through a network or other means, where the network may include a wireless network, a wired network, and/or any combination of a wireless network and a wired network.

A driver 1010 is also connected to the input/output interface 105 as needed. A removable medium 1011 such as a magnetic disk, an optical disc, a magneto-optical disc, and a semiconductor memory is mounted on the driver 1010 as needed, so that a computer program read therefrom is installed into the storage part 108 as needed.

In the case where the above-described series of processes are implemented by software, a program constituting the software may be installed from a network such as the Internet or a storage medium such as the removable medium 1011.

According to the embodiments of the present disclosure, the processes described above with reference to the flowcharts may be implemented as computer software programs. For example, some embodiments of the present disclosure include a computer program product that, when running on a computer, causes the computer to implement the method according to any of the embodiments. The computer program product includes computer instructions carried on a computer-readable medium, and includes program code for performing the method shown in the flowchart. In such an embodiment, the computer instructions may be downloaded and installed from a network through the communication part 109, or installed from the storage part 108, or installed from the ROM 102. When the computer program is executed by the CPU 101, the method in the embodiments of the present disclosure is executed.

It should be noted that in the context of the present disclosure, the computer-readable medium may be a tangible medium that may contain or store a program for use by or in combination with an instruction execution system, apparatus, or device.

The computer-readable medium may be a computer-readable storage medium, a computer-readable signal medium, or any combination thereof.

The computer-readable storage medium includes, but is not limited to, an electrical, magnetic, optical, electromagnetic, infrared, or semiconductor system, apparatus, or device, or any combination thereof. More specific examples of the computer-readable storage medium may include, but are not limited to, an electrically connected portable computer magnetic disk having one or more wires, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. The computer-readable storage medium has computer instructions stored thereon, and the instructions, when executed by a processor, implement the method according to any of the embodiments.

The computer-readable signal medium may include a data signal propagated on a baseband or as a part of a carrier, and computer-readable program code is carried thereon. This propagated data signal may take many forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including but not limited to a wire, an optical cable, a radio frequency (RF), or any suitable combination thereof.

The above computer-readable medium may be included in the above electronic device, or may exist alone without being assembled into the electronic device.

In some embodiments, there is further provided a computer program including: instructions that, when executed by a processor, cause the processor to perform the method according to any of the embodiments. For example, the instructions may be embodied as computer program code.

In the embodiments of the present disclosure, the computer program code for performing the operations of the present disclosure may be written in one or more programming languages or a combination thereof, where the programming languages include, but are not limited to, an object-oriented programming language such as Java, Smalltalk, and C++, and further include conventional procedural programming languages such as “C” language or similar programming languages. The program code may be executed entirely on a user computer, partly executed on a user computer, executed as an independent software package, partly executed on a user computer and partly executed on a remote computer, or entirely executed on a remote computer or server. In the case involving a remote computer, the remote computer may be connected to the user computer through any kind of network (including a local area network (LAN) or a wide area network (WAN)), or may be connected to an external computer (for example, connected by using Internet provided by an Internet service provider).)

The flowcharts and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be performed at least partially by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logic device (CPLD), and the like.

Although some specific embodiments of the present disclosure have been described in detail by way of examples, those skilled in the art should understand that the above examples are only for illustration, rather than limiting the scope of the present disclosure. Those skilled in the art should understand that the above embodiments may be modified without departing from the scope and spirit of the present disclosure. The scope of the present disclosure is defined by the appended claims.

What is claimed is

1. An interaction method, comprising:
displaying one or more pieces of recommended demand information, in response to a user inputting visual media content, wherein the one or more pieces of recommended demand information are determined by understanding the visual media content and match the visual media content, and the one or more pieces of recommended demand information are configured for representing one or more intents for the visual media content;
determining a work link corresponding to target recommended demand information, in response to a trigger operation of the user on the target recommended demand information from the one or more pieces of recommended demand information; and
displaying answer content, wherein the answer content is generated based on the visual media content and the work link.

2. The interaction method of claim 1, wherein the determining the work link corresponding to the target recommended demand information comprises:
understanding the target recommended demand information, and determining one or more work nodes required for generating the answer content corresponding to the target recommended demand information and a sequence of the one or more work nodes, wherein the one or more work nodes comprise at least one of a model, an application, a plug-in, or an agent; and
determining the work link based on the one or more work nodes and the sequence of the one or more work nodes.

3. The interaction method of claim 2, wherein the understanding the visual media content, and determining the one or more pieces of recommended demand information matching the visual media content comprises:
understanding the visual media content by a machine learning model, and determining at least one of an entity or a scene in the visual media content; and
determining one or more pieces of recommended demand information from first-type recommended demand information, second-type recommended demand information, and third-type recommended demand information based on the at least one of the entity or the scene, wherein the first-type recommended demand information comprises recommended demand information for modifying the visual media content, the second-type recommended demand information comprises recommended demand information for asking a question about the visual media content, and the third-type recommended demand information comprises recommended demand information for generating reply information based on the visual media content and feeding back the reply information in the visual media content.

4. The interaction method of claim 3, wherein the understanding the target recommended demand information, and determining the one or more work nodes required for generating the answer content corresponding to the target recommended demand information comprises:
determining that the one or more work nodes comprise a visual understanding node and a modification node, in response to the target recommended demand information being the first-type recommended demand information, wherein the visual understanding node is configured to understand the visual media content to obtain understanding information, and the modification node is configured to modify the visual media content based on the understanding information and the target recommended demand information.

5. The interaction method of claim 3, wherein the understanding the target recommended demand information, and determining the one or more work nodes required for generating the answer content corresponding to the target recommended demand information comprises:
determining that the one or more work nodes comprise a visual understanding node, a search node, and a generation node, in response to the target recommended demand information being the second-type recommended demand information, wherein the visual understanding node is configured to understand the visual media content to obtain understanding information, the search node is configured to search for information related to a question about the visual media content based on the understanding information and the target recommended demand information, and the generation node is configured to generate an answer based on the information related to the question about the visual media content.

6. The interaction method of claim 3, wherein the understanding the target recommended demand information, and determining the one or more work nodes required for generating the answer content corresponding to the target recommended demand information comprises:
determining that the one or more work nodes comprise a visual understanding node, a reply information determination node, and an addition node, in response to the target recommended demand information being the third-type recommended demand information, wherein the visual understanding node is configured to understand the visual media content to obtain understanding information, the reply information determination node is configured to determine reply information based on the understanding information and the target recommended demand information, and the addition node is configured to add the reply information to the visual media content.

7. The interaction method of claim 3, wherein the generating the answer content based on the visual media content and the work link, and displaying the answer content comprises at least one of:
generating modified visual media content based on the visual media content and the work link, and displaying the modified visual media content in an interaction interface, in response to the target recommended demand information being the first-type recommended demand information;
generating an answer to a question about the visual media content based on the visual media content and the work link, and displaying the answer in an interaction interface, in response to the target recommended demand information being the second-type recommended demand information; or
generating reply information corresponding to the visual media content based on the visual media content and the work link, and adding and displaying the reply information in the visual media content, in response to the target recommended demand information being the third-type recommended demand information.

8. The interaction method of claim 1, wherein the one or more pieces of recommended demand information matching the visual media content is determined based on at least one of historical interaction information corresponding to the user or a behavior habit of the user, and the understanding of the visual media content.

9. The interaction method of claim 3, wherein the visual media content comprises multiple images, and the at least one of the entity or the scene in the visual media content comprises at least one of an entity or a scene of each image of the multiple images; and the determining one or more pieces of recommended demand information from first-type recommended demand information, second-type recommended demand information, and third-type recommended demand information based on the at least one of the entity or the scene comprises:
determining a theme and key elements of the multiple images based on the at least one of the entity or the scene of each image; and
determining the one or more pieces of recommended demand information from the first-type recommended demand information, the second-type recommended demand information, and the third-type recommended demand information based on the theme and the key elements of the multiple images.

10. The interaction method of claim 3, wherein the visual media content comprises a video, and the at least one of the entity or the scene in the visual media content comprises at least one of an entity or a scene of a key frame in the video; and the determining one or more pieces of recommended demand information from first-type recommended demand information, second-type recommended demand information, and third-type recommended demand information based on the at least one of the entity or the scene comprises:
determining a theme and key elements of the video based on the at least one of the entity or the scene of the key frame; and
determining the one or more pieces of recommended demand information from the first-type recommended demand information, the second-type recommended demand information, and the third-type recommended demand information based on the theme and the key elements of the video.

11. The interaction method of claim 1, wherein the displaying one or more pieces of recommended demand information, in response to a user inputting visual media content comprises:
displaying a camera control;
displaying a preview interface in response to the user triggering the camera control; and
displaying the one or more pieces of recommended demand information in the preview interface, in response to the user completing a photographing operation for the visual media content, wherein the one or more pieces of recommended demand information are displayed in the preview interface.

12. The interaction method of claim 11, wherein the displaying the one or more pieces of recommended demand information, in response to a user inputting visual media content further comprises:
displaying a confirmation control in the preview interface, in response to the user completing a photographing operation for the visual media content; and
displaying an interaction interface, and displaying the one or more pieces of recommended demand information in the interaction interface, in response to the user triggering the confirmation control.

13. The interaction method of claim 1, wherein the displaying one or more pieces of recommended demand information, in response to a user inputting visual media content further comprises:
displaying a selection control;
displaying one or more pieces of candidate visual media content, in response to the user triggering the selection control; and
displaying the visual media content and displaying the one or more pieces of recommended demand information in a preview interface, in response to the user selecting the visual media content from the one or more pieces of candidate visual media content.

14. An electronic device, comprising:
a processor; and
a memory coupled to the processor and configured to store instructions, wherein the instructions, when executed by the processor, cause the processor to:
display one or more pieces of recommended demand information, in response to a user inputting visual media content, wherein the one or more pieces of recommended demand information are determined by understanding the visual media content and match the visual media content, and the one or more pieces of recommended demand information are configured for representing one or more intents for the visual media content;
determine a work link corresponding to target recommended demand information, in response to a trigger operation of the user on the target recommended demand information from the one or more pieces of recommended demand information; and
display the answer content, wherein the answer content is generated based on the visual media content and the work link.

15. The electronic device according to claim 14, wherein the determining the work link corresponding to the target recommended demand information comprises:
understanding the target recommended demand information, and determining one or more work nodes required for generating the answer content corresponding to the target recommended demand information and a sequence of the one or more work nodes, wherein the one or more work nodes comprise at least one of a model, an application, a plug-in, or an agent; and
determining the work link based on the one or more work nodes and the sequence of the one or more work nodes.

16. The electronic device according to claim 15, wherein the understanding the visual media content, and determining the one or more pieces of recommended demand information matching the visual media content comprises:
understanding the visual media content by a machine learning model, and determining at least one of an entity or a scene in the visual media content; and
determining one or more pieces of recommended demand information from first-type recommended demand information, second-type recommended demand information, and third-type recommended demand information based on the at least one of the entity or the scene, wherein the first-type recommended demand information comprises recommended demand information for modifying the visual media content, the second-type recommended demand information comprises recommended demand information for asking a question about the visual media content, and the third-type recommended demand information comprises recommended demand information for generating reply information based on the visual media content and feeding back the reply information in the visual media content.

17. The electronic device according to claim 16, wherein the understanding the target recommended demand information, and determining the one or more work nodes required for generating the answer content corresponding to the target recommended demand information comprises:
determining that the one or more work nodes comprise a visual understanding node and a modification node, in response to the target recommended demand information being the first-type recommended demand information, wherein the visual understanding node is configured to understand the visual media content to obtain understanding information, and the modification node is configured to modify the visual media content based on the understanding information and the target recommended demand information.

18. A non-transitory computer-readable storage medium having a computer program stored thereon, wherein the program, when executed by a processor, cause the processor to:
display one or more pieces of recommended demand information, in response to a user inputting visual media content, wherein the one or more pieces of recommended demand information are determined by understanding the visual media content and match the visual media content, and the one or more pieces of recommended demand information are configured for representing one or more intents for the visual media content;
determine a work link corresponding to target recommended demand information, in response to a trigger operation of the user on the target recommended demand information from the one or more pieces of recommended demand information; and
display the answer content, wherein the answer content is generated based on the visual media content and the work link.

19. The non-transitory computer-readable storage medium according to claim 18, wherein the determining the work link corresponding to the target recommended demand information comprises:
understanding the target recommended demand information, and determining one or more work nodes required for generating the answer content corresponding to the target recommended demand information and a sequence of the one or more work nodes, wherein the one or more work nodes comprise at least one of a model, an application, a plug-in, or an agent; and
determining the work link based on the one or more work nodes and the sequence of the one or more work nodes.

20. The non-transitory computer-readable storage medium according to claim 19, wherein the understanding the visual media content, and determining the one or more pieces of recommended demand information matching the visual media content comprises:
understanding the visual media content by a machine learning model, and determining at least one of an entity or a scene in the visual media content; and
determining one or more pieces of recommended demand information from first-type recommended demand information, second-type recommended demand information, and third-type recommended demand information based on the at least one of the entity or the scene, wherein the first-type recommended demand information comprises recommended demand information for modifying the visual media content, the second-type recommended demand information comprises recommended demand information for asking a question about the visual media content, and the third-type recommended demand information comprises recommended demand information for generating reply information based on the visual media content and feeding back the reply information in the visual media content.
